(19) United States
(12) Patent Application Publication
(10) Pub. No.: US 2013/0291459 A1
(43) Pub. Date: Nov. 7, 2013

(54) Unit Glazing Construction for Window Panels

(71) Applicant: John Frey, Los Angeles, CA (US)

(72) Inventor: John Frey, Los Angeles, CA (US)

(73) Assignee: C.R. Laurence Co., Inc., Los Angeles, CA (US)

(21) Appl. No.: 13/868,941

(22) Filed: Apr. 23, 2013

Related U.S. Application Data
(60) Provisional application No. 61/642,263, filed on May 3, 2012.

(51) Int. Cl. E06B 3/54

(52) U.S. Cl. CPC E06B 3/5409
USPC 52/204.591; 52/656.5

(57) ABSTRACT

A system for creating single and double pane window walls comprising mullions, sills, headers, other framing members and gasketing, is disclosed. The system features window pane framing extrusions which include provisions that allow the extrusions to snap together to create a framing member with a box-type cross-section. Experimentation has shown that the composite box sections have similar structural properties to unitary box sections, i.e. comparable moments of inertia and cross-sectional area and thus comparable ability to carry bending moment, transmit shear and resist buckling.

### PRIORITY CLAIM

This application claims priority, from U.S. Provisional Application Ser. No. 61/642,263, filed in May 3, 2012, entitled IMPROVED UNIT GLAZING CONSTRUCTION FOR WINDOW PANELS.

### FIELD OF THE INVENTION

The invention relates to unit glazing of window panels, and more particularly to an improved structure for framing the glass panels used in window wall structures.

### BACKGROUND OF THE INVENTION

Window walls are widely used as the exterior sheathing of commercial buildings, and in particular, high rise buildings. Window walls typically consist of glass panels defining a major portion of the exterior surface of the building, with structural members separating the glass panels. A typical glass panel will be framed with structural members, i.e. with vertical members or mullions which connect to a lower horizontal member or sill and an upper horizontal member or header.

Modern window walls frequency make use of double pane window construction. In double frame construction, each window frame contains two parallel panes of glass separated by an air space. Double pane construction has two notable advantages over single pane construction, i.e., double pane windows substantially reduce exterior noise and have greater thermal efficiency than single pane windows.

One issue with either type of construction is how to seal the glass panes from the elements. Sealing of the window glass panes to the structural members is referred to as glazing. In general there are two types of glazing, i.e. traditional adhesive sealants such as RTV or elastomeric gaskets (i.e. rubber gaskets), or a combination of both. The modern trend has been to use elastomeric gaskets to seal the glass panes to the window framing structure. The window walls are then attached to a building's structural members via mechanical fasteners and seated around their perimeter with an adhesive sealant such as RTV.

One of the major costs associated with window walls is the labor required to make the walls at the jobsite. Making the walls requires cutting the framing members, i.e. mullions, sills and headers to size, cutting the rubber gaskets (glazing), and then building the window frame from the cut materials and installing the glass panes and elastomeric gaskets. The completed window wall frames are then installed in the building, typically using a combination of mechanical fasteners and adhesive sealants.

As may be seen, there remains a seed In the art for a system of framing window walls that reduces the labor cost associated with construction of window walls at the jobsite. Ideally, such a system would allow for the window walls to be constructed in a factory, leaving only the installation of the prefabricated walls to be done at the jobsite.

### SUMMARY AMD OBJECTS OF THE INVENTION

The invention comprises an apparatus and method for constructing prefabricated window walls in a factory. There are several advantages to prefabricating window walls in the controlled environment of a factory. In a factory setting, increased quality control and efficiency is possible through mass production of file window walls. All components needed to produce the walls can be readily stocked and labor savings may be achieved because the tasks necessary to fabricate the walls can be split up into a series of individual tasks that can be readily performed by lower skilled workers.

The system of the present invention comprises window wall framing members, i.e. vertical center mullions, intermediate horizontal framing members, vertical end mullions and horizontal headers and sills, of novel design which can be used to build either double or single pane window walls. In the exemplary embodiment, each center mullion and intermediate horizontal framing member comprises two aluminum extrusions which include provisions that allow the extrusions to snap together to create a composite, closed section, structure. When snapped together the mullions and intermediate horizontal framing members are generally in the shape of two hollow box sections interconnected by a web. Experimentation has shown that the composite box sections have similar structural properties to continuous box sections, i.e. comparable moments of inertia and cross-sectional area and thus have comparable ability to carry bending moment, transmit shear and resist buckling. The headers, sills and vertical end mullions of the present invention use a box type cross-section with a snap in close-out panel.

In fabricating either double or single pane window walls, the glass panes of the wall are captured between the framing members and are sealed at their outer surfaces by rubber gasketing. In the ease of double pane construction, the desired air gap between the panes is maintained by spacers. The spacers are positioned such that they are internal of the outer surface of the box sections of the mullions.

Each of the window frame assemblies with make up a window wall is square cut. Therefore, the sills, headers and end mullions of the window walls may be attached to the supporting building walls into which the window walls are set by means of mechanical fasteners such as screw races.

It is an object of the present invention to lower unit labor costs, improve quality control, and increase productivity by producing prefabricated window walls using standard parts on an assembly line. Other objects and advantages of the present invention will become apparent in the course of the following description.

### BRIEF DESCRIPTION OF THE DRAWINGS

FIG. 1 is an exemplary installation of a window wall in accordance with the present invention.

FIG. 2 is an exemplary cross-sectional view of center mullions and intermediate horizontal framing members for use with double pane windows, showing the snapped together configurations in accordance with the present invention.

FIG. 3 is an exemplary cross-sectional view of the center mullions and intermediate horizontal framing members of FIG. 2, shown in the open configuration, in accordance with the present invention.

FIG. 4 is art exemplary cross-sectional view of header, sill and end mullion framing members for double pane windows, in accordance with the present invention.

FIG. 5 is in exemplary cross-sectional view of center millions and intermediate horizontal framing members for use with single pane windows, in accordance with the present invention.

FIG. 6 is an exemplary cross-sectional view of header, sill and end million framing members for single pane windows, in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

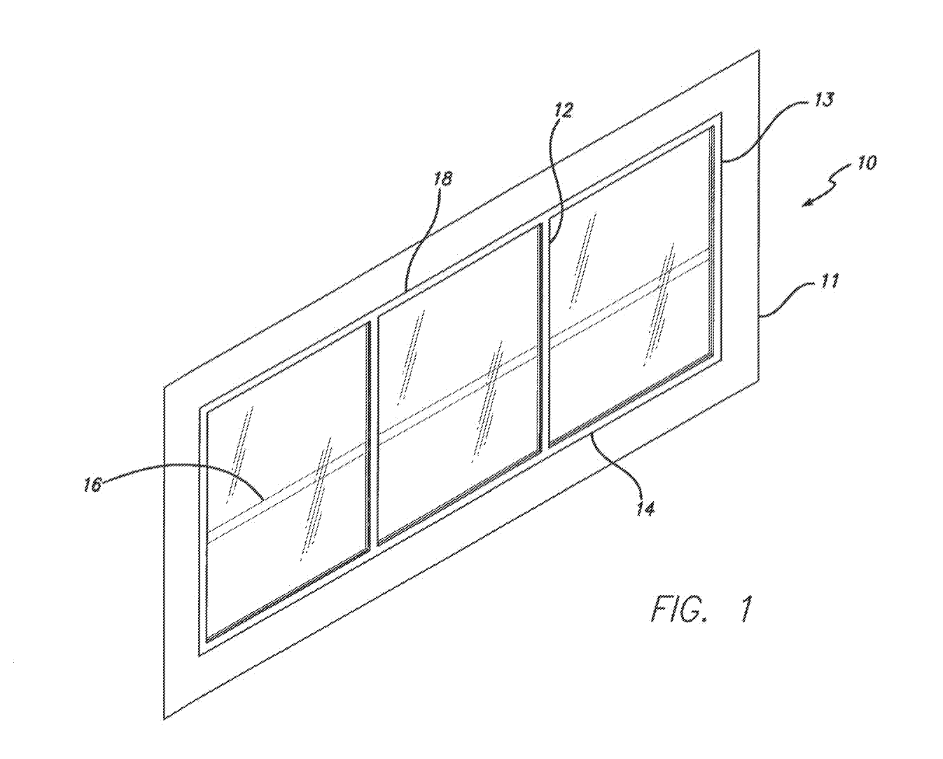

Referring to FIG. 1, the window wall construction system of the present invention 10 comprises window framing members including vertical center mullions 12, vertical end mullions 13, horizontal lower sills 14, intermediate horizontal framing members 16, and horizontal upper headers 18. These components are used to frame window walls within a supporting or structural wall 11. In the exemplary embodiment, the vertical and horizontal members are square cut and attached to each other and supporting walls by means of mechanical fasteners, with screws and screw races being preferred. (The use of screws and screw races is knows to those of skill in the art.)

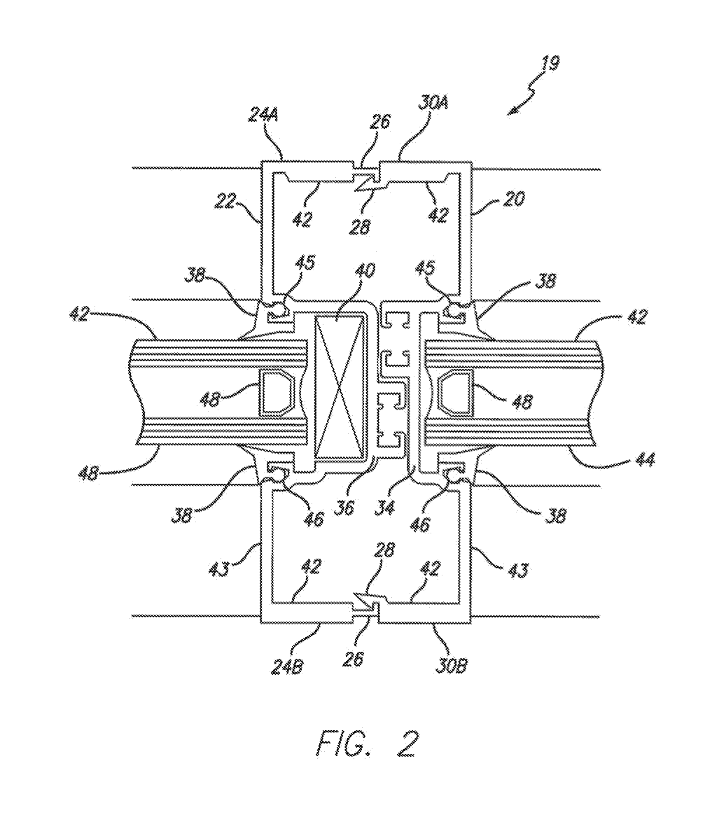

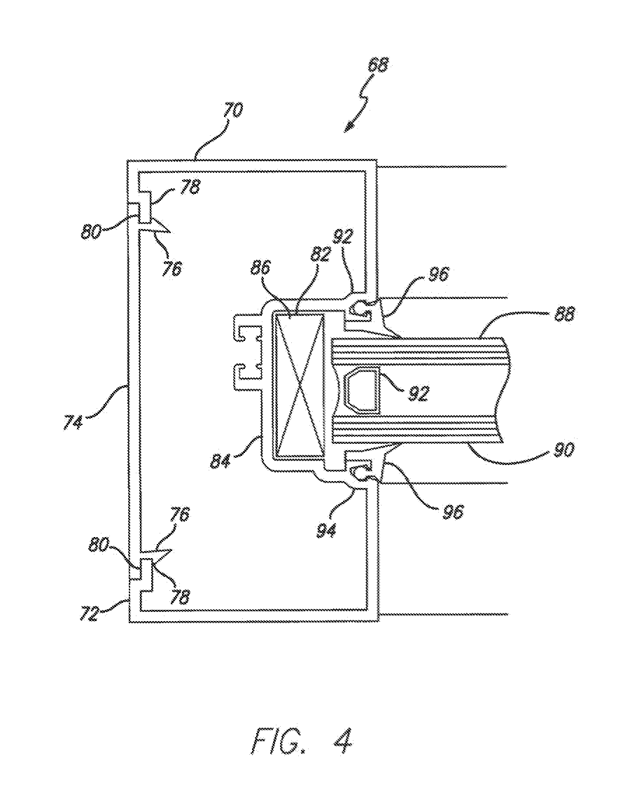

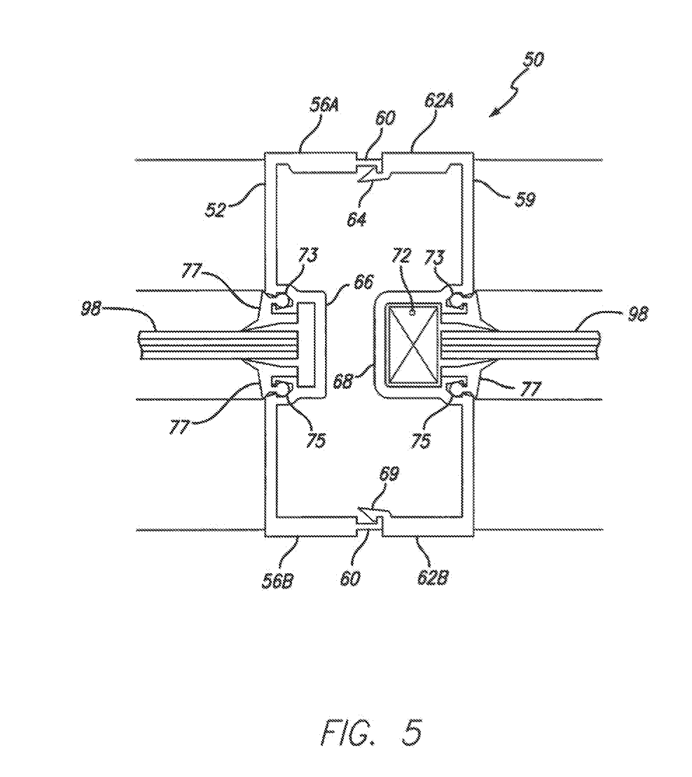

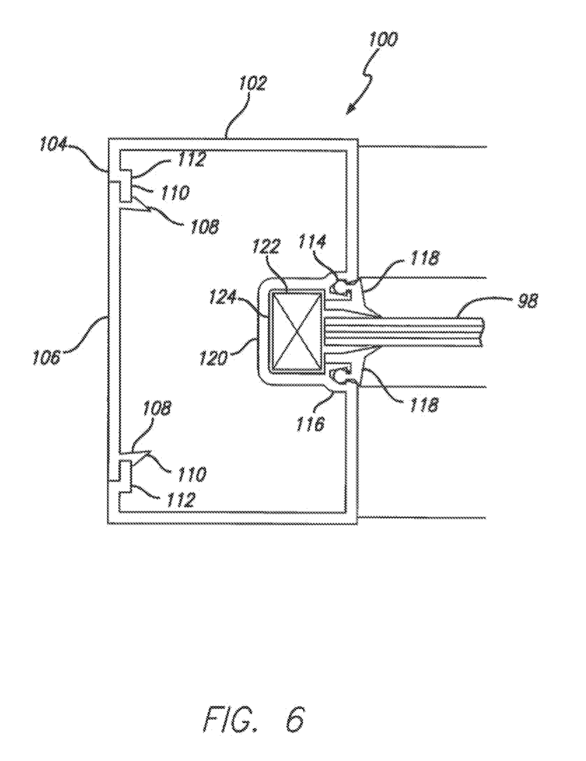

The exemplary composite cross-sections of FIGS. 2-4, illustrate double pane window wall construction while the exemplary composite cross-sections of FIGS. 5-6 illustrate single pane window wall consumption. The exemplary composite framing member cross-sections of FIGS. 2-3 and 5 are illustrative of the concepts used for center millions and intermediate horizontal framing members in accordance with the present invention. The exemplary composite framing member cross-sections of FIGS. 4 and 6 are illustrative of the concepts used for sills, headers and vertical end mullions in accordance with the present invention. The system of the present invention 10 has wide applicability to both residential and commercial construction.

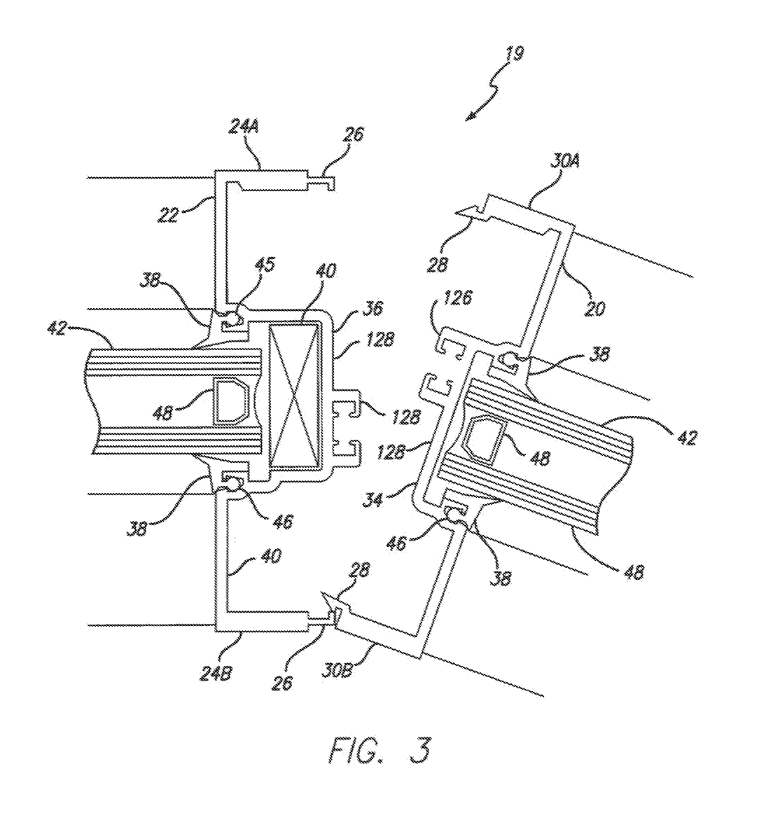

Referring to FIGS. 2-3, an exemplary composite cross-section 19 suitable for use with the vertical center millions 12 and intermediate horizontal framing members 16 of the present invention, intended for use in double pane window wall construction, is shown. The exemplary composite cross-section 19 of the center mullions 12 and intermediate horizontal framing members 16 comprises left and right extrusions, 22 and 20 respectively. The left extrusion 22 includes upper and lower cap members 24A and 24B. Extending from a side edge of each upper and lower cap member 24A and 24B is a hook member 26. The right extrusion 20 has similar upper and lower cap members 30A and 30B. Extending from a side edge of each of the upper and lower cap members is 30A and 30B is a catch member 28. The hook members 26 of the left extrusion 22 and the catch members 28 of the right extrusion 20 are formed such that the right and left extrusions snap together to form the composite cross-section 19, which is the basis for the center mullions 12 and intermediate horizontal framing members 16.

One advantage of the snap together construction of the present invention, is that mechanical fasteners, i.e. screws and the like, can be used to connect the vertical mullions 12 to the horizontal sills 14, headers 18 or intermediate horizontal framing members 16. The screw heads used to make these connections are hidden when the extrusions 20 and 22 which form the mullions 12 are snapped together.

The left extrusion 22 of the composite cross-section 19 is complex multi-channel shape which includes a window pane channel 36 for receipt of two spaced apart panes of window glass 42 and 44. The window panes 42 and 44 are separated by a spacer 48. An air gap is maintained between the glass panes by means of the spacer 48. The window pane channel 36 of the extrusion 22 is of sufficient size to hold a setting block 40. The left extrusion 22 also includes upper and lower gasketing channels 45 and 46, for the receipt of window pane gasketing 38.

The right extrusion 20 of the composite cross-section 19 is also generally in the form of a complex multi-channel shape. The right extrusion 20 also includes a window pane channel 34 for receipt of two spaced apart panes of window glass 42 and 44. The window panes 42 and 44 are separated by a spacer 48. The spacer 48 maintaining an air gap between the glass panes 42 and 44. The right extrusion 22 also includes upper and lower gasketing channels 45 and 46, for the receipt of window pane gasketing 38.

The window panes 42 and 44 are sealed or glazed to the framing members by means of the elastomeric gasketing 38. (Glaring is a term of art used in the window installation industry. Although the term originally referred to the use of putty-like glazing compounds, the term now includes gasketing with elastomeric materials.) The glazing or gasketing prevents air and water intrusion past the window panes.

With reference to FIG. 3, during assembly of a window wall, the right and left hand extrusions 22 and 20, of a particular center mullion 12 or intermediate horizontal framing member 16, are hooked together at their lower cap members 24B and 30B, via hook member 26 and catch member 28, in an open position as shown in FIG. 3. The right and left extrusions 22 and 20 are then rotated upwardly and inwardly so that the hook member 26 extending from the upper cap member 24A of the left extrusion 22 engages the catch member 28 of the upper cap member 30A of the right extrusion 20, and snap together. In this manner, the left and right extrusions 22 and 20, form the composite cross-section 19.

The composite cross-section 19 is in the overall form of a box section. Experimentation has shown that composite box sections can have similar structural properties to continuous box sections, i.e. the composite box may have comparable moments of inertia and cross-sectional area to a continuous box section of the same dimensions and wall thickness and thus have comparable ability to carry bending moment, transmit shear and resist buckling. Analysis verified by experimental results has shown that by increasing the wall thickness 42 of the upper and lower cap members 24A, 24B, 30A and 30C, the wall thickness of the remaining walls of the extrusions 20 and 22 can be reduced without sacrificing the load carrying capacity of the framing-members which use the composite cross-section 19, and like composite cross-sections. Generally, the wall thickness 42 of the upper and lower cap members should be about 1.5 times, or greater, than that of the wall thickness 43 of the web portions of the composite cross section.

With reference to FIG. 3, the right and left extrusions 20 and 22, may also include abutment channels 126 and abutment surfaces 128, wherein the abutment channel 126 on the right extrusion 20 abuts the abutment surface 128 on the left extrusion 22 and the abutment channel 126 on the left extrusion 22 abuts the abutment surface 128 on the right extrusion 20, when the extrusions are snapped together. The abutment channels 126 and abutment surfaces 128 serve to stabilize the framing members under bending and compressive loads.

Referring now to FIG. 4, an exemplary composite cross-section 68 of a sill 14, header 18, or end mullion 13, of the present invention, for use in double pane window wall construction, is shown. The cross-section 68 comprises an open channel extrusion 70 which is enclosed on three sides and has an open outer side 72. The open outer side 72 is closed out by a closeout panel 74. The closeout panel 74 features catch members 76 which engage with a protruding end or hook member 78 of a step surface 80 formed into the outer wall 72 of the channel 70. Like the right and left extrusions 22 and 20 of the composite cross-section 19, the exemplary composite cross-section 68 also features upper and lower gasketing channels 92 and 94 for securing elastomeric gasketing 96. The exemplary composite cross-section 68 further includes a window pane channel 82, which is sized to receive a setting block 86, as well as the window panes 88 and 90. The setting block 82 serves to space the window panes 88 and 90 from an inner wall 84 of the open channel 70. In the double pane window construction illustrated by FIG. 4, a spacer 86 is used to maintain an air gap between the window panes 88 and 90.

Referring now to FIG. 5, an exemplary composite cross-section 50 suitable for use with vertical center mullions 12 and intermediate horizontal, framing members 16 of the present invention, intended for use in single pane window wall construction, is shown. The cross-section 50 comprises left and right extrusions, 52 and 54 respectively. The left extrusion 52 includes upper and lower cap members 56A and 56B. Extending from a side edge of each upper and lower cap member 56A and 56B is a hook member 60. The right extrusion 54 has similar upper and lower cap members 62A and 62B. Extending from a side edge of each of the upper and lower cap members 62A and 62B is a catch member 64. The hook members 60 of the left extrusion 52 and the catch members 64 of the right extrusion 52 are formed such that the right and left extrusions snap together Co form the composite cross-section 50.

The left extrusion 52 includes a window pane channel 66 for receipt of a single pane of window glass 98. The left extrusion also includes upper and lower gasketing channels 73 and 75 for the receipt of window pane gasketing 77. The right extrusion 54 likewise includes a window pane channel 68 for receipt of a single pane of window glass 98. The window pane channel 68 of the right extrusion 54 is sized to be sufficiently large to receive a setting block 72. The right extrusion 54 also includes gasketing channels 45 for the receipt of window gasketing 46.

Referring now to FIG. 6, an exemplary composite cross-section 100 of a sill 14, header 18, or end mullion 13, of the present invention, for use in single pane window wall construction, is shown. The composite cross-section 100 comprises an open channel extrusion 102 which is enclosed on three sides and has an open side 104. The open side 104 is closed out by a closeout panel 106. The closeout panel 106 features hook members 108 which engage with a protruding end or catch member 110 of a step surface 112 formed into the open side 104 of the channel 70. Like the right and left extrusions 52 and 54 of the cross-section 50, the exemplary cross-section 100 also features upper and lower gasketing channels 114 and 116 for securing elastomeric gasketing 118. The exemplary cross-section 68 further includes a window pane channel 120, which is sized to receive a setting block 122, as well the window pane 98. The setting block 122 serves to space the window pane 98 from an inner wall 124 of the window pane channel 120.

Suitable materials for the extrusions which comprise the exemplary composite cross-sections of the several types of framing members described above include various aluminum alloys, other metallic materials such as stainless steel, as well as many types of plastics. Suitable materials and methods of producing extrusions are known to those of skill in the art. Any material that can be extruded or formed into the disclosed shapes is potentially suitable. The window pane gasketing can be made from several types of elastomeric materials, which are known to those of skill in the art.

The foregoing detailed description and appended drawings are intended as a description of the presently preferred embodiments of the invention and are not intended to represent the only forms in which the present invention may be constructed and/or utilized. Those skilled in the art will understand that modifications and alternative embodiments of the present invention which do not depart from the spirit and scope of the foregoing specification, drawings, and appendix of the claims Mow are possible and practical. It is intended that the claimed invention covers all such modifications and alternative embodiments.

1. An intermediate window wall framing member having a composite cross-section comprising:
a left extrusion and a right extrusion, the left and right extrusions having upper and lower cap members and intermediate web members interconnecting the upper and lower cap members;
the upper and lower cap members on one extrusion having a hook member extending from each cap member;
the upper and lower cap members on the other extrusion having a catch member extending from each cap member; and
wherein the hook and catch members extending from the cap members are engageable so as to snap together to form a composite cross-section from the right and left extrusions.

2. The intermediate window wall framing member having a composite cross-section of claim 1, wherein the intermediate web portions of the right and left extrusions include a window pane channel for the receipt of one or more window panes, the window pane channel having an upper end and a lower end.

3. The intermediate window wall framing member having a composite cross-section of claim 2, wherein the intermediate web portions of the right and left extrusions include gasketing channels, one of the gasketing channels being located adjacent to the upper end of the window pane channel and one of the gasketing channels being located adjacent to the lower end of the window pane channel.

4. The intermediate window wall framing member having a composite cross-section of claim 2, wherein at least one of the window pane channels is of sufficient depth to receive a setting block.

5. The intermediate window wall framing member having a composite cross-section of claim 1, wherein the upper and lower cap members have a thickness of at least 1½ times the thickness of the intermediate web members.

6. The intermediate window wall framing member having a composite cross-section of claim 3, wherein disposed within the gasketing channels is an elastomeric gasket.

7. The intermediate window wall framing member having a composite cross-section of claim 2, wherein the window channels have sufficient depth to receive two panes of window glass separated by a spacer.

8. The intermediate window wall framing member having a composite cross-section of claim 1, wherein the right and left extrusions further include abutment channels and abutment surfaces, wherein the abutment channel in the right extrusion abuts the abutment surface on the left extrusion and the abutment channel on the left extrusion abuts the abutment surface on the right extrusion, when the extrusions are snapped together.

9. An intermediate wall window framing member having a composite cross-section comprising:
a left extrusion and a right extrusion, the left and right extrusions having upper and lower cap members and intermediate web members interconnecting the upper and lower cap members;
the upper and lower cap members on one extrusion having a hook member extending from each cap member;
the upper and lower cap members on one extrusion having a catch member extending from each cap member;
wherein the hook and catch members extending from the cap members are engageable so as to snap together to form a composite cross-section from the right and left extrusions; and
wherein the intermediate web portions of the right and left extrusions include a window pane channel for the receipt of one or more window panes, the window pane channel having as upper end and a lower end; and
wherein the intermediate web portions of the right and left extrusions include gasketing channels, one of the gasketing channels being located adjacent to the upper end of the window pane channel and one of the gasketing channels being located adjacent to the lower end of the window pane channel.

10. The intermediate window wall framing member having a composite cross-section of claim 9, wherein at least one of the window pane channels includes sufficient depth to receive a setting block.

11. The intermediate window wall framing member having a composite cross-section of claim 9, wherein the upper and lower cap members have a thickness at least 1½ times the thickness of the intermediate web members.

12. The intermediate window wall framing member having a composite cross-section of claim 9, wherein disposed within the gasketing channels is an elastomeric gasket.

13. The intermediate window wall framing member having a composite cross-section of claim 9, wherein the window channels have sufficient depth to receive two panes of window glass separated by a spacer.

14. The intermediate window wall framing member having a composite cross-section of claim 9, wherein the right and left extrusions further include abutment channels and abutment surfaces, wherein the abutment channel on the right extrusion abuts the abutment surface on the left extrusion and the abutment channel on the left extrusion abuts the abutment surface on the right extrusion, when the extrusions are snapped together.

15. An end window wall framing member having a composite cross-section comprising:
an extrusion of continuous cross-section on three sides, having one open side;
a closeout panel for closing off the open side of the extrusion;
means for engaging the closeout panel with the extrusion; and
a window pane channel having an upper end and a lower end, formed into a side of the extrusion opposite from the open side, for receipt of one or more window panes.

16. The end window wall framing member having a composite cross-section of claim 15, further including gasketing channels, one of the gasketing channels being located adjacent to the upper end of the window pane channel and one of the gasketing channels being located adjacent to the lower end of the window pane channel.

17. The end window wall framing member having a composite cross-section of claim 16, wherein disposed within the gasketing channels is an elastomeric gasket.

18. The end window wall framing member having a composite cross-section of claim 15, wherein the means for engaging the closeout panel with the extrusion comprise hook and snap elements.

19. A system for building window walls, comprising:
window wall framing members including at least one end framing member and at least one intermediate framing member;
the at least one end framing member comprising:
an extrusion of continuous cross-section on three sides, having one open side;
a closeout panel for closing off the open side of the extrusion;
means for engaging the closeout panel with the extrusion; and
a window pane channel having an tipper end and a lower end, formed into a side of fie extrusion opposite from the open side, for receipt of one or more window panes;
the at least one intermediate framing member, comprising:
a left extrusion and a right extrusion, the left and right extrusions having upper and lower cap members and intermediate web members interconnecting the upper and lower cap members;
the upper and lower cap members on one extrusion having a hook member extending from each cap member;
the upper and lower cap members on one extrusion having a catch member extending from each cap member; and
wherein the hook and catch members extending from the cap members are engageable so as to snap together to form a composite cross-section from the right and left extrusions;
wherein the intermediate web portions of the right and left extrusions include a window pane channel for the receipt of one or more window panes, the window pane channel having an upper end and a lower end; and
a plurality of window panes connected to the window wall framing members.

20. The system for building window walls of claim 19, further comprising a gasketing channel adjacent to the upper end of the window pane channel and a gasketing channel adjacent to the lower end of the window pane channel.
